(19) United States
(12) Patent Application Publication
(10) Pub. No.: US 2019/0077593 A1
(43) Pub. Date: Mar. 14, 2019

(54) WIND RESISTANT TRASH RECEPTACLE

(71) Applicant: Maxwell Gallo, Fair Lawn, NJ (US)

(72) Inventor: Maxwell Gallo, Fair Lawn, NJ (US)

(21) Appl. No.: 16/127,709

(22) Filed: Sep. 11, 2018

Related U.S. Application Data
(60) Provisional application No. 62/556,600, filed on Sep. 11, 2017.

(51) Int. Cl. B65F 1/14

(52) U.S. Cl. CPC B65F 1/141

(57) ABSTRACT

A container system is provided. The container system includes a canister, a holding vessel configured to house the canister, at least one housing coupled to the holding vessel, each of the at least one housings configured to house at least one attachment mechanism, and the at least one attachment mechanism configured to secure the housing to a surface.

### CLAIM OF PRIORITY

This application claims priority to U.S. Provisional Patent Application No. 62/556,600, filed Sep. 11, 2017, incorporated by reference herein in its entirety.

### FIELD OF THE EMBODIMENTS

The field of the embodiments relates to trash receptacles and, more particularly, to trash receptacles resistant to tipping during weather phenomena.

### BACKGROUND OF THE EMBODIMENTS

Waste management services typically do not enter homes to collect waste. Typically, waste receptacle, such as garbage cans, have to be left outside for the waste management services to collect the contents. Due to the time of day that this waste is collected, many individuals often put the waste receptacles out the night before collection. This leaves the waste receptacles to the elements, subjecting them to possible winds, rains, and other weather-related events which can leave the waste receptacles tipped, causing their contents to be spilled.

This problem invites other undesirable elements, such as, e.g., rodents and insects, and also may cause dangerous driving conditions due to the spilled waste. For at least these reasons, a need exists for a way of securing a trash can in hazardous conditions, while also making the trash can easily moveable.

U.S. Pat. No. 836,555 generally describes a garbage can that includes coaction between the can proper and its cover, whereby the latter may be interlocked with the can for effectually preventing dogs or cats from displacing the cover and gaining access to the contents of the receptacle and often overturning the same for engagement with set posts or stakes for securely keeping the can always in an upright position on the ground.

U.S. Pat. No. 4,413,851 generally describes a retainer strap for holding in closed position a lid, preferably having a top handle, upon a container, such as refuse or garbage can, having opposed open-loop side handles. One end portion of the strap is folded back upon itself and slidably retained by a buckle member to form an adjustable first loop extending through one of the open-loop side handles, while the opposite end of the strap extends through the opposite side handle and is folded back upon itself and retained in a fixed second loop by a pair of detachable snap fasteners. The middle portion of the strap either extends through or over the top handle of the lid, and the buckle member is adjusted to tighten the strap in operative position against the lid to hold the lid in closed position upon the container.

U.S. Pat. No. 5,897,018 generally describes a garbage can including a weighted base having a recess formed therein. Also described is a garbage can having a bottom adapted to be releasably situated within the recess of the base. Next provided is a plurality of locking tabs for coupling the can within the base.

U.S. Pat. No. 6,644,493 generally describes a weighted garbage can with legs that has a receptacle with a rounded weighted base such that the empty garbage can will tend to remain upright and will upright itself if tipped. The weighted garbage can with legs also has retractable legs that function in conjunction with a spring suspended inner platform to retract when the garbage can is empty and extend as the receptacle is filled. The legs extend as the receptacle is filled to stabilize the can as the self-uprighting tendency is overcome when the filled receptacle becomes top-heavy.

U.S. Pat. No. 7,762,418 generally describes a garbage can unit with weighted base that includes a garbage can, a housing, a wheel assembly, and a T-shaped handle attached to the housing. The can is made cylindrical and provided with a flange at its upper peripheral edge and a pair of handles integrally formed on diametrically opposite sides of the can. The housing is made in the form of a parallelepiped, with a bulged bottom portion, a cylindrical recess being made in the housing to receive the can. The bulged bottom portion of the housing is made hollow and provided with a closeable inlet having a plug and located at a front side of the bulged portion to allow filling an inner space of the bulged bottom portion with filler. The wheel assembly includes a pair of wheels on a common axle attached to a rear side of the bulged portion.

U.S. Patent Publication No. 2006/0278645 generally describes an apparatus to restrain a garbage can from unwanted movement having an inner annulus and or an outer annulus interconnected with a container with the outer annulus and or the container receiving weighting means including rocks, sand, concrete, spikes or liquids. The container formed to receive a garbage can to withstand unintended tipping of the garbage can.

U.S. Patent Publication No. 2007/0209846 generally describes a remote controlled motorized garbage can that is capable of transferring material to the intended designation, in conjunction, an automatic lid opener apparatus to facilitate in the dispersing of material and the lid comprising a lock and sensor mechanism to prevent personal, financial and other such information readily accessible for unlawful inclinations. To transfer the container by a remote control, rather than manual exertion, provides an efficient, convenient and permits accessibility, in consideration, to almost all individuals of physical ability.

U.S. Patent Publication No. 2009/0050627 generally describes a lid weight attachable to a movable lid of a garbage can. While particularly effective with hinged lid cans, the lid weight may be used with any garbage can configurations. When used with hinged lid cans, a single weight is typically sufficient. When used with removable lid cans, pairs of weights are desirable. One or more weights are suspended from a lid by a resilient strap. The downward pressure exerted on the garbage can lid by the attached weight(s) effectively secures the can lid to the can body. The weight(s) effectively lowers the center of gravity of the garbage can, therefore providing resistance to lateral forces, such as those exerted by a crosswind. The novel weight system is readily attachable to any trash, refuse, garbage, or similar container.

U.S. Patent Publication No. 2015/0375920 generally describes a system for dispensing trash bags comprises a dispenser including an opening from which stored trash bags may be removed. A prong is positioned to extend partially across the opening of the dispenser. In an additional embodiment, the dispenser is stored within a container having a plurality of exterior walls, an upper opening, and a floor. The floor of the dispenser contains an elevated portion with an aperture extending therethrough. A prong is positioned to extend partially across the aperture. In additional embodiments, the disclosure pertains to methods of removing a trash bag from a dispenser where the bag comes into contact with a prong extending either from the dispenser or the container. The prong acts to at least partially unfold the bag upon removal from the dispenser, aiding the user in securing the trash bag to a garbage can.

None of the art described above addresses all of the issues that the present invention does. The present application provides, among other things, a container system made up of a canister, a lid, a holding vessel, at least a first housing and a second housing located on a surface of the holding vessel, an attachment mechanism configured to couple with the canister and lid, and a first stake and a second stake coupled to the first housing the second housing respectively. The present application further ensures, among other things, that the trash container is kept upright, that the lid does not come off the canister and is easily moved after use.

### SUMMARY OF THE EMBODIMENTS

According to an aspect of the present invention, a container system is provided. The container system includes a canister, a holding vessel configured to house the canister, at least one housing coupled to the holding vessel, each of the at least one housings configured to house at least one attachment mechanism, and the at least one attachment mechanism configured to secure the housing to a surface.

It is an object of the present invention to provide the container system, wherein the container system further includes a lid.

It is an object of the present invention to provide the container system, wherein the container system further includes an attachment mechanism configured to secure the lid to the canister.

It is an object of the present invention to provide the container system, wherein the attachment mechanism is positioned on an outer surface of the holding vessel.

It is an object of the present invention to provide the container system, wherein the container system further includes one or more contact pads coupled to an inner surface of the holding vessel, wherein the one or more contact pads are configured to prevent movement of the canister within the holding vessel.

It is an object of the present invention to provide the container system, wherein at least one of the one or more contact pads has a concave surface configured to be in contact with the canister.

It is an object of the present invention to provide the container system, wherein at least one of the one or more contact pads has a convex surface configured to be in contact with the canister.

It is an object of the present invention to provide the container system, wherein the one or more contact pads includes a deformable surface configured to be in contact with the canister.

It is an object of the present invention to provide the container system, wherein one or more of the at least one attachment mechanisms include a flange on one end.

It is an object of the present invention to provide the container system, wherein the container system further includes a support apparatus coupled to a bottom portion of the holding vessel.

It is an object of the present invention to provide the container system, wherein a plurality of attachment mechanisms are connected to each other.

It is an object of the present invention to provide the container system, wherein the container system further includes a transportation mechanism coupled to the holding vessel.

It is an object of the present invention to provide the container system, wherein the transportation system includes one or more wheels.

It is an object of the present invention to provide the container system, wherein one or more wheels are operatively connected to one or more attachment mechanisms.

It is an object of the present invention to provide the container system, wherein the transportation system includes a braking mechanism.

It is an object of the present invention to provide the container system, wherein the holding vessel includes one or more apertures on a bottom surface of the holding vessel.

It is an object of the present invention to provide the container system, wherein the holding vessel includes one or more materials selected from the group consisting of: plastic; metal; and rubber.

It is an object of the present invention to provide the container system, wherein the at least one attachment mechanism includes at least one stake.

### BRIEF DESCRIPTION OF THE DRAWINGS

FIG. 1 shows a top view of a wind resistant trash receptacle having no canister inserted and having one or more contact pads coupled to an inner portion of a holding vessel of the wind resistant trash receptacle, according to an embodiment of the present invention.

FIG. 2 shows a perspective view of the wind resistant trash receptacle having no canister inserted and having one or more contact pads coupled to an inner portion of the holding vessel of the wind resistant trash receptacle, according to an embodiment of the present invention.

FIG. 3 shows an exploded perspective view of the wind resistant trash receptacle having a canister and having one or more contact pads coupled to an inner portion of the holding vessel of the wind resistant trash receptacle, according to an embodiment of the present invention.

FIG. 4 shows a sectional side view of a holding vessel of a wind resistant trash receptacle having a contact pad, according to an embodiment of the present invention.

FIG. 5 shows a sectional perspective view of a holding vessel of a wind resistant trash receptacle having a contact pad, according to an embodiment of the present invention.

FIG. 6 shows a top view of a wind resistant trash receptacle having no canister inserted and having no contact pads coupled to an inner portion of the holding vessel of the wind resistant trash receptacle, according to an embodiment of the present invention.

FIG. 7 shows a perspective view of the wind resistant trash receptacle having no canister inserted and having no contact pads coupled to an inner portion of the holding vessel of the wind resistant trash receptacle, according to an embodiment of the present invention.

FIG. 8 shows an exploded perspective view of the wind resistant trash receptacle having a canister and having no contact pads coupled to an inner portion of the holding vessel of the wind resistant trash receptacle, according to an embodiment of the present invention.

FIG. 9 shows an exploded perspective view of the wind resistant trash receptacle having a canister and holding vessel having a rectangular shape, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

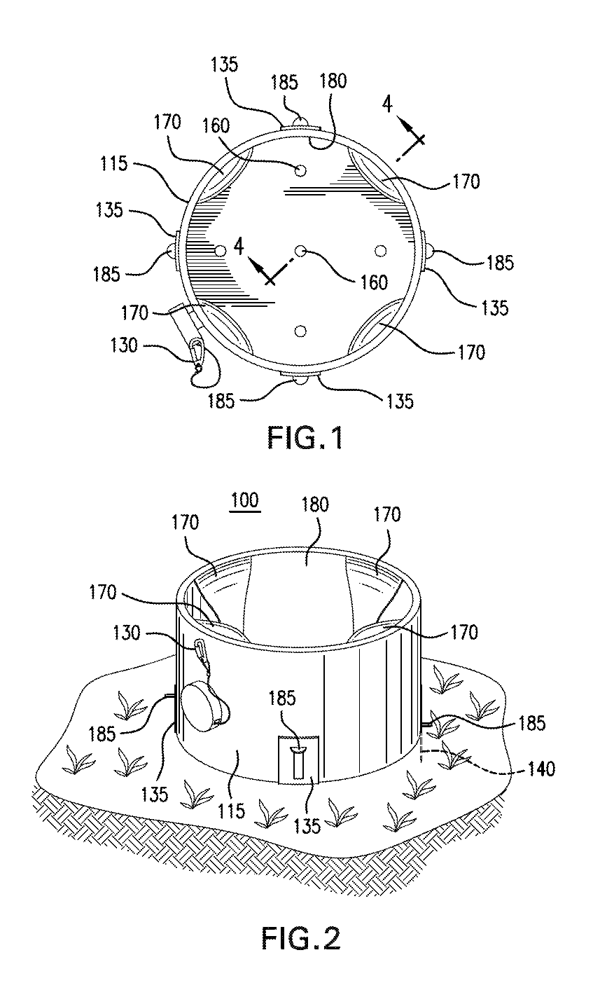

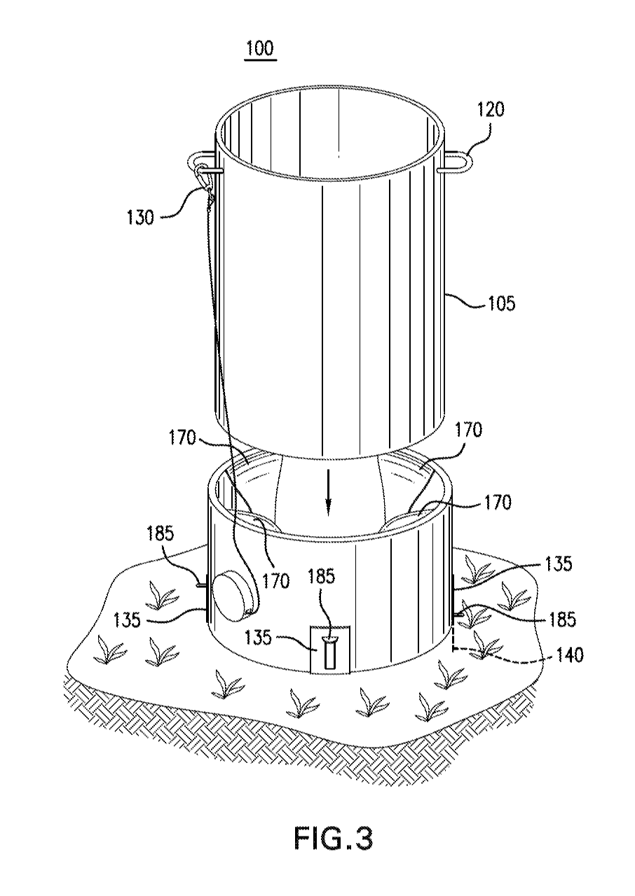

Referring now to FIGS. 1-2, a top view (FIG. 1) and a perspective view (FIG. 2) of a wind resistant trash receptacle 100 having one or more contact pads 170 coupled to an inner portion 180 of a holding vessel 115 of the wind resistant trash receptacle 100 are illustratively depicted, in accordance with an embodiment of the present invention. The canister 105 is illustratively depicted in FIG. 3, which illustratively depicts an exploded view of the wind resistant trash receptacle 100, in accordance with an embodiment of the present invention.

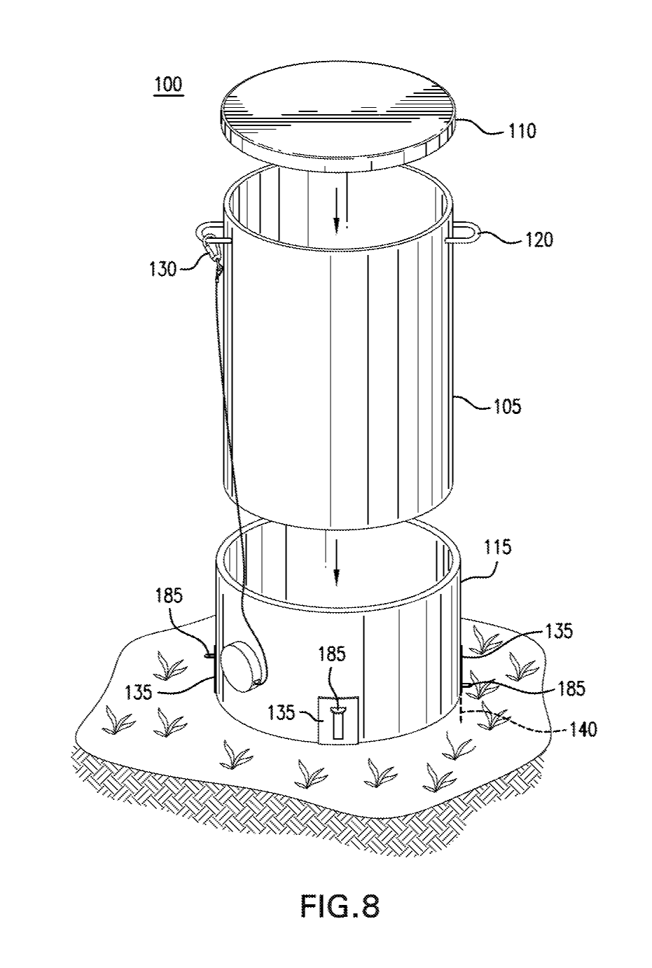

According to an embodiment, the wind resistant trash receptacle 100 includes a canister 105 and a holding vessel 115 configured to house the canister 105. According to an embodiment, the wind resistant trash receptacle 100 further includes a lid 110 covering the canister (an example of which is shown in FIG. 8). According to an embodiment, the canister 105 is configured to hold waste. However, it is noted that the canister 105 may be configured to hold other items, while maintaining the spirit of the present invention. According to an embodiment, the canister 105 may include, e.g., plastic, rubber, metal, composite material, and/or any other suitable material. According to an embodiment, the canister 105 may be tubular, round, and/or any other suitable shape and may be of any suitable size. According to an embodiment, the canister 105 may include solid walls. According to an embodiment, the walls of the canister 105 may contain holes, forming a cage-like shape, decreasing the weight of the canister 105.

The holding vessel 115 is configured to house the canister 105. According to an embodiment, the holding vessel 115 has a solid flat bottom. It is noted, however, that any suitably shaped bottom may be incorporated. According to an embodiment, the holding vessel 115 includes one or more apertures 160 along a bottom portion of the holding vessel 115. These apertures 160 enable liquid to drain from the holding vessel 115.

According to an embodiment, the wind resistant trash receptacle 100 further includes an attachment mechanism 130 configured to secure the canister 105 to the holding vessel 115. The attachment mechanism 130 may be any suitable securing device for securing the canister 105 to the holding vessel 115. According to an embodiment, the attachment mechanism 130 includes a clip, cord, string, and/or other similar device, which may or may not be retractable. According to an embodiment, the attachment mechanism 130 includes one or more clips, hook and loop fasteners, buttons, and/or any other suitable fastening mechanism. According to an embodiment, the attachment mechanism 130 may be configured to secure the lid 110 to the holding vessel 115.

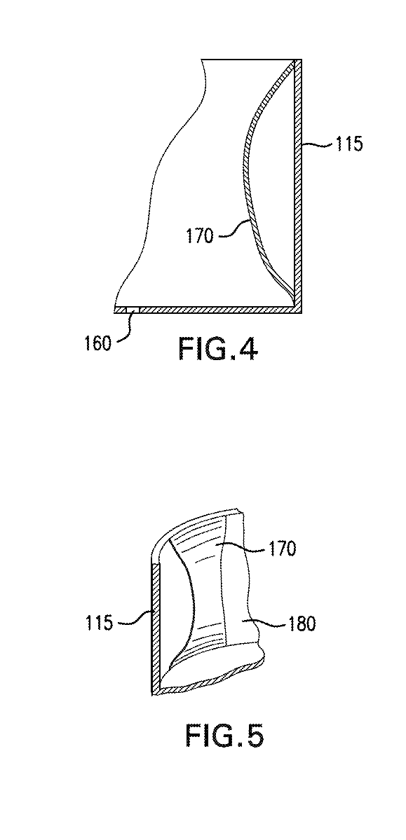

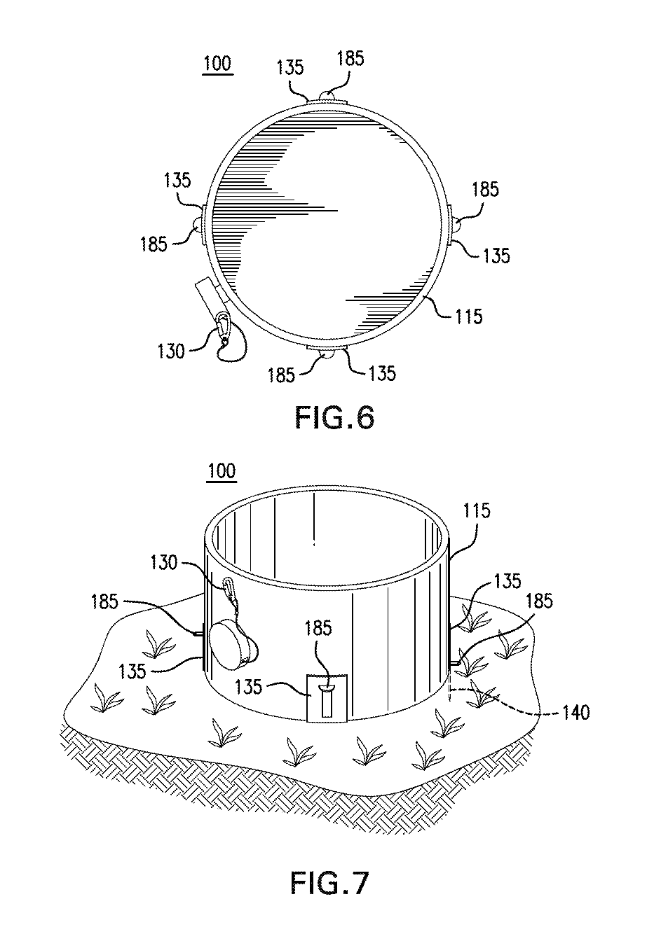

According to an embodiment, one or more contact pads 170 are positioned on an inner portion 180 of the holding vessel 115. The one or more contact pads 170 are configured to secure the canister 105 in place once the canister 105 is positioned within the holding vessel 115. According to an embodiment, the contact pads 170 are rigid. According to an embodiment, the contact pads 170 are deformable. Being deformable helps cushion and damper the movement of the canister 105 inside the holding vessel 115. According to an embodiment, the contact pad 170 includes a convex surface facing the canister 105. According to an embodiment, the contact pad 170 includes a concave surface facing the canister 105. A sectional side view (FIG. 4) and a sectional perspective view (FIG. 5) of the holding vessel 115, showing a contact pad 170 can be seen in FIGS. 4-5. According to an embodiment, the holding vessel 115 does not include any contact pads 170 coupled to an inner surface 180 of the holding vessel 115. A top view (FIG. 6), a perspective view (FIG. 7), and an exploded perspective view (FIG. 8) of the wind resistant trash receptacle 100 having no contact pads 170 coupled to the inner surface 180 of the holding vessel 115 are illustratively depicted in FIGS. 6-8.

According to an embodiment, the holding vessel 115 includes one or more housings 135 coupled to an outer surface of the holding vessel 115. According to an embodiment, the one or more housings 135 may be separate components from the holding vessel 115. According to an embodiment, the one or more housings 135 and the holding vessel 115 comprise a unitary structure.

According to an embodiment, one or more of the one or more housings 135 are configured to receive one or more attachment mechanisms 140 configured to mount the holding vessel 115 to a surface. According to an embodiment, at least one of the one or more attachment mechanisms 140 includes a serrated edge. According to an embodiment, at least one of the one or more attachment mechanisms 140 includes a smooth edge. According to an embodiment, at least one of the one more attachment mechanisms 140 includes a plurality of connected stakes. The one or more stakes 140 may include, e.g., plastic, metal, composite material, and/or any other suitable material. It is noted, however, that the attachment mechanisms 140 may be of any suitable shape for securing the vessel 115 to a surface.

According to an embodiment, the one or more attachment mechanisms 140 are partially covered by the one or more housings 135 while still enabling a user to push the one or more attachment mechanisms 140 down to secure the holding vessel 115, and to pull the one or more attachment mechanisms 140 back up, in order to release the holding vessel 115. According to an embodiment, the receiving portion 155 of the one or more housings 135 is configured to guide the attachment mechanisms and keep them upright, enabling the one or more attachment mechanisms 140 to be inserted vertically. It is noted, however, that the one or more housings 135 may be configured to enable the one or more attachment mechanisms 140 to be inserted at any suitable angle. According to an embodiment, one or more of the attachment mechanisms 140 include a flange 185 that protrudes partially or wholly from the housing 135 for use in inserting and removing the attachment mechanisms 140. According to an embodiment, two or more of the attachment mechanisms 140 are connected.

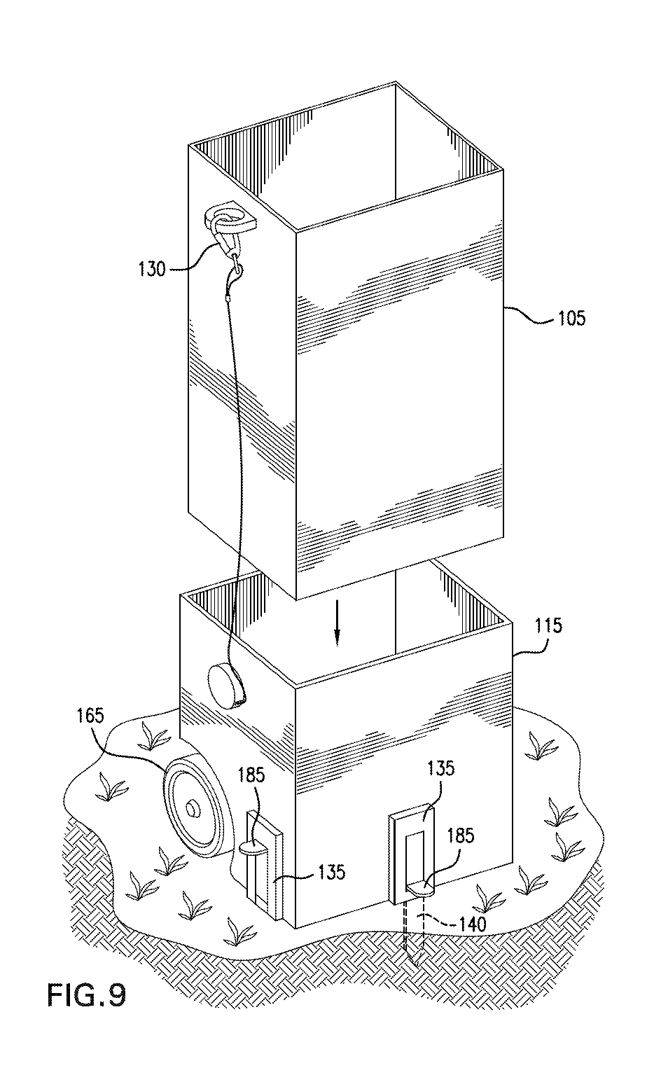

According to an embodiment, the canister 105 and holding vessel 105 may be rectangular (as shown in FIG. 9) and/or any other suitable shape.

According to an embodiment, the wind resistant trash receptacle 100 includes a transportation mechanism 165. According to an embodiment, the transportation mechanism 165 includes one or more wheels (as shown in FIG. 9). According to an embodiment, the wheels 165 are coupled to the holding vessel 115. According to an embodiment, the wheels 165 are coupled to one or more of the attachment mechanisms 140 such that when the attachment mechanisms 140 are positioned in a down position, the wheels 165 are disengaged. According to an embodiment, the disengagement can take place by having the wheels lifted off the ground, by having a brake (through a braking mechanism) applied such that the wheels aren't able to move, or through any other suitable means.

As shown in FIGS. 1-2, the one or more attachment mechanisms 140 are positioned on an outer surface of the holding vessel 115. However, it is noted that one or more of the attachment mechanisms 140 may be positioned elsewhere. According to an embodiment, one or more of the attachment mechanisms 140 are coupled along an inner portion of the holding vessel 115. Positioning the one or more attachment mechanisms 140 along the inner portion of the holding vessel 115 provides more security for the attachment mechanisms 140. Furthermore, housing one or more attachment mechanisms along the inner portion of the holding vessel 115 provide apertures 160 in the base of holding vessel 115, configured to receive the attachment mechanisms 140, which can be useful for draining liquid, aiding in the prevention of the wind resistant trash receptacle 100 gaining weight due to liquid buildup.

According to an embodiment, the wind resistant trash receptacle 100 may take the form of a kit for constructing the wind resistant trash receptacle 100. According to an embodiment, the kit is retrofitted onto an existing holding vessel 115 and used in combination with a pre-existing canister 150. According to an embodiment, the kit includes a holding vessel 115, at least one attachment mechanism 140, and/or an attachment mechanism 145. According to an embodiment, the kit 400 further includes a set of wheels 160.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A container system comprising:
a canister;
a holding vessel configured to house the canister;
at least one housing coupled to the holding vessel, each of the at least one housings configured to house at least one attachment mechanism; and
the at least one attachment mechanism configured to secure the housing to a surface.

2. The container system as recited in claim 1, further comprising a lid.

3. The container system as recited in claim 2, further comprising an attachment mechanism configured to secure the lid to the canister.

4. The container system as recited in claim 3, wherein the attachment mechanism is positioned on an outer surface of the holding vessel.

5. The container system as recited in claim 1, further comprising one or more contact pads coupled to an inner surface of the holding vessel, wherein the one or more contact pads are configured to prevent movement of the canister within the holding vessel.

6. The container system as recited in claim 5, wherein at least one of the one or more contact pads has a concave surface configured to be in contact with the canister.

7. The container system as recited in claim 5, wherein at least one of the one or more contact pads has a convex surface configured to be in contact with the canister.

8. The container system as recited in claim 5, wherein the one or more contact pads includes a deformable surface configured to be in contact with the canister.

9. The container system as recited in claim 1, wherein one or more of the at least one attachment mechanisms include a flange on one end.

10. The container system as recited in claim 1, further comprising a support apparatus coupled to a bottom portion of the holding vessel.

11. The container system as recited in claim 1, wherein a plurality of attachment mechanisms are connected to each other.

12. The container system as recited in claim 1, further comprising a transportation mechanism coupled to the holding vessel.

13. The container system as recited in claim 12, wherein the transportation system includes one or more wheels.

14. The container system as recited in claim 13, wherein one or more wheels are operatively connected to the at least one attachment mechanisms.

15. The container system as recited in claim 12, wherein the transportation system includes a braking mechanism.

16. The container system as recited in claim 1, wherein the holding vessel includes one or more apertures on a bottom surface of the holding vessel.

17. The container system as recited in claim 1, wherein the holding vessel includes one or more materials selected from the group consisting of plastic; metal; and rubber.

18. The container system as recited in claim 1, wherein the at least one attachment mechanism includes at least one stake.
